(19) United States
(12) Patent Application Publication
(10) Pub. No.: US 2011/0103929 A1
(43) Pub. Date: May 5, 2011

(54) METHOD AND APPARATUS FOR THE TRANSPORTING AND SORTING OF ARTICLES BY USE OF A CONTAINER

(75) Inventor: ARMIN ZIMMERMANN, KONSTANZ (DE)

(73) Assignee: SIEMENS AKTIENGESELLSCHAFT, Munchen (DE)

(21) Appl. No.: 12/917,861

(22) Filed: Nov. 2, 2010

Related U.S. Application Data
(60) Provisional application No. 61/257,235, filed on Nov. 2, 2009.

(30) Foreign Application Priority Data
Nov. 2, 2009 (DE) 10 2009 051 663.8

(51) Int. Cl. B65G 57/00; B07C 5/00; B65G 59/00

(52) U.S. Cl. 414/802; 209/509

(57) ABSTRACT

A method and an apparatus for the transporting and sorting of articles uses a container. The container extends along a container axis and has a bottom wall and a plurality of parallel walls. The bottom wall stands perpendicular to the container axis, and the parallel walls are parallel to the container axis. One parallel wall is connected pivotably to another parallel wall of the container. The container is brought into a filling position in which the container stands on a parallel wall. The pivotably fastened parallel wall points upward, so that an orifice occurs. The articles are introduced into the container through this orifice. The container, together with the articles, is transported to a destination and brought into a transfer position. The container stands on a parallel wall. The pivotably fastened parallel wall points to one side. An orifice thereby occurs. The articles are extracted through this orifice.

### CROSS-REFERENCE TO RELATED APPLICATION

This application claims the priority, under 35 U.S.C. §119, of German application DE 10 2009 051 663.8, filed Nov. 2, 2009; this application claims the priority, under 35 U.S.C. §119(e), of provisional application No. 61/257,235, filed Nov. 2, 2009; the prior applications are herewith incorporated by reference in their entirety.

### BACKGROUND OF THE INVENTION

### Field of the Invention

The invention relates to a method and an apparatus for the transporting and sorting of articles, in particular of flat mail consignments, by use of a container.

In order to sort mail consignments, mail consignments from pick-up points and letterboxes are introduced into containers and are transported in these containers to a sorting plant. The sorted mail consignments are introduced into containers again and are brought in these containers, for example, to a delivery mail office. A mail delivery worker uses a container in order to deliver mail consignments. In this case, the delivery worker extracts mail consignments from the container in succession. The containers can be re-used for various transport tasks.

U.S. Pat. No. 5,857,830 describes an arrangement and sorting method for flat mail consignments. The arrangement possesses a sorting plant, a rack wall, a robot and a multiplicity of containers (“cartridges”). The sorting plant possesses a supply device, an outfeed device and a multiplicity of sorting end points which are arranged in a matrix. The rack wall has a multiplicity of parking places for containers. Each container possesses a rectangular bottom and two wide and two narrow side walls. The robot can bring an empty container out of a parking place of the rack wall into a sorting end point, so that the outfeed device can generate a stack of flat mail consignments in this container. Furthermore, the robot can extract a full container from a sorting end point and place it on a parking place of the rack wall and transport it from a parking place of the rack wall to the supply device. During this transport of the supply device, the container is rotated about a vertical axis of rotation and placed onto a conveyor belt of the supply device.

German patent DE 103 26 495 B3, corresponding to U.S. Pat. No. 7,442,896, describes a method for the processing of mail consignments. The mail consignments 100 are collected at various mailing points and transported in transport containers 120 to letter centers. A sorting device 110 possesses a plurality of extraction locations 130. A conveyor stage 140 transports filled containers 120 intermittently to the extraction locations 130. Transport containers 120 filled at loading points 105 have previously been placed onto the conveyor stage 140. In one embodiment, a transfer device 135 places filled transport containers 120 from the conveyor stage 140 onto a further conveyor stage 145. A transport container 120 slips from the conveyor stage 140 obliquely downward onto the transfer device 135.

U.S. Pat. No. 6,026,967 describes a sorting plant (“article handling system 10”) with a supply device (“autofeeder 50”), an outfeed device (“sorter 15”) and a matrix of output units (“array 19 of output compartments 20”), see FIG. 1. The output units 20 are arranged in a plurality of rows and columns. Each output unit 20 can receive a special container (“cartridge 25”). The sorting plant 10 in each case generates a stack of flat mail consignments in each container 25. FIG. 1 shows the sorting plant 10 and a rack wall (“buffer shelf 40”). The rack wall 40 contains a multiplicity of parking places (“array of compartments 45”). A container 25 can be placed on each parking place 45. A handling robot (“handling robot 30”) can transport containers 25 back and forth between the output units 20 of the sorting plant and parking places 45 of the rack wall. The rack wall 40, in one embodiment, possesses an undercarriage with rollers. The rack wall 40 can therefore be moved back and forth between a reception position and a discharge position. In the reception position, the handling robot 30 brings filled containers 25 from an output unit 20 into a corresponding parking place 45 of the rack wall 40, see FIG. 11A to FIG. 11C. In the discharge position, filled containers 25 can be brought out of the rack wall 40 onto the supply device 50, see FIG. 11D to FIG. 11F.

European patent EP 1 049 545 B1 describes a sorting plant (“high output dispatch system 20”). Each “dispatch subsystem 22” possesses a “transport mechanism 50” with a plurality of parking places for containers. A “vertical lift 56” can move a parking place having a container up and down, see FIG. 7. A further mechanism can displace a container into a holding device (“associated cart 52”) by a “horizontal movement”. The container can be moved up and down in the holding device 52.

Sorting plants with containers are also described in U.S. Pat. No. 6,501,041 B1 and in U.S. Pat. No. 5,421,464.

International patent disclosure WO 87/02808 A1 describes an arrangement with a cartridge 1. The cartridge 1 possesses a bottom, two wide side walls, two narrow side walls and a “cover assembly”. A grip 14 is fastened to one narrow side wall. The “cover assembly” contains an “outer cover member 11” and “inner cover member 12”. The “inner cover member 12” can press down a stack (“bundle 13”) of flat articles, for example banknotes, in the inner space of the cartridge 1. The rectangular “outer cover member 11” can be pivoted back and forth between a closed position and an open position. In the closed position, the “outer cover member 11” extends parallel to the bottom and closes the inner space. In the open position, the “outer cover member 11” is arranged parallel to a narrow side wall and conceals this narrow side wall. The “inner cover member 12” can likewise be pivoted back and forth between an open position and a closed position, for example as a result of rotation of the “inner cover member 12” about a longitudinal axis. The “inner cover member 12” is connected rotatably to a wide side wall. The opposite wide side wall, that is to say that side wall which is not connected to the “inner cover member 12”, possesses a rectangular clearance at the upper end, so that this opposite wide side wall is less high than that wide side wall to which the “inner cover member 12” is connected. In the open position, the “inner cover member 12” functions as an extension of one wide side wall. If both “cover members 11, 12” have been pivoted into the closed position, the “outer cover member 11” conceals the “inner cover member 12”.

In order to fill the cartridge 1, the “outer cover member 11” and the “inner cover member 12” are both brought into the open position. The cartridge 1 thereby has an upwardly pointing orifice, through which articles can be introduced into the inner space, see FIGS. 2A, 2B, 2C. For example, banknotes are introduced horizontally and slide downward, and a rest (“plate 21”) under the horizontally lying banknotes descends downward, so that a stack of banknotes is obtained on the rest 21. A “compacting device 26” compresses the stack of banknotes. After as many banknotes as is stipulated are introduced into the inner space of the cartridge 1, first the “inner cover member 12” and then the “outer cover member 11” are pivoted into the closed position. In order to extract banknotes from the inner space of the cartridge 1, the rest 21 pushes the stack upward. In one embodiment, banknotes can be pushed away from the stack, for example by a conveyor belt or a roller, by a horizontal movement parallel to the bottom, through the clearance above the opposite wide side wall.

Containers for flat mail consignments and other articles are described, inter alia, in published, non-prosecuted German patent application DE 198 35 233 A1 (corresponding to U.S. Pat. No. 6,503,044), German patent DE 102 34 516 B4 (corresponding to U.S. Pat. No. 7,210,597), German patent DE 10 2006 029 889 B3, non-prosecuted German patent application DE 10 2004 019 322 A1, German utility model DE 202 008 0017 46 U1 and non-prosecuted German patent application DE 102 11 716 A1.

European patent EP 1 227 985 B2 (corresponding to U.S. Pat. No. 6,598,756) and U.S. Pat. No. 5,865,334 describe containers with foldable side walls.

### SUMMARY OF THE INVENTION

It is accordingly an object of the invention to provide a method and an apparatus for the transporting and sorting of articles by use of a container which overcome the above-mentioned disadvantages of the prior art methods and devices of this general type, in which the risk of damage to the articles during loading or unloading is reduced.

With the foregoing and other objects in view there is provided, in accordance with the invention a method for transporting a plurality of stackable articles using at least one container containing an inner space extending along a container axis, a bottom wall, and a plurality of parallel walls. The bottom wall and the parallel walls delimit the inner space. The bottom wall stands perpendicular to the container axis. Each of the parallel walls is disposed parallel to the container axis, and one of the parallel walls is a pivotably fastened parallel wall connected pivotably to another one of the parallel walls. The method includes the step of: bringing the container into a filling position in which the container stands on one of the parallel walls, so that the container axis runs horizontally, and the pivotably fastened parallel wall points upward and is opened so that an upwardly pointing orifice occurs; introducing the stackable articles into the inner space of the container from above through the upwardly pointing orifice, so that the stackable articles, after being introduced, form a stack located in the container; transporting the container, together with the articles, to a destination; and bringing the container at the destination into a transfer position by rotating the container, together with the articles in the container, about the container axis. In the transfer position, the container stands on one of the parallel walls, so that the container axis runs horizontally, and the pivotably fastened parallel wall points to one side, so that a side orifice pointing to the one side occurs. The stack with the articles is extracted from the inner space of the container through the side orifice pointing to the one side.

According to the solution, at least one container is used, preferably a plurality of identical containers.

Each container used extends along a container axis wall. The container contains a bottom and a plurality of parallel walls. The bottom wall stands vertically on the container axis. The parallel walls are arranged parallel to the container axis. One parallel wall is connected pivotably, in particular rotatably, to another parallel wall of the container.

As a result of the method, a plurality of stackable articles are transported. The method contains the now described steps.

Each container used is brought into a filling position. In the filling position, the container stands on a parallel wall. The container axis of the container runs horizontally. The pivotably fastened parallel wall points upward. The parallel wall is opened, so that an upwardly pointing orifice occurs in the container.

The stackable articles are introduced into the inner space of the container from above through the orifice. The articles thereby form a stack located in the container after they have been introduced into the container.

The container, together with articles stacked in the container, is transported to a destination.

The container is brought at the destination into a transfer position. In the transfer position, the container stands on a parallel wall. The container axis of the container runs horizontally. The pivotably fastened parallel wall of the container points to one side. This gives rise in the container to an orifice pointing to this side.

The stack having the articles is extracted from the inner space of the container through the orifice pointing to the side.

The step of bringing the container out of the filling position into the transfer position contains the step of rotating the container, together with the articles located in the inner space of the container, about the container axis. It is possible that the container axis runs horizontally while the container is being brought out of the filling position into the transfer position. It is also possible that the container is brought out of the transfer position first into a third position in which the container axis stands vertically or obliquely, the container is subsequently rotated about a vertical or oblique axis and then the rotated container is brought into the transfer position.

Rotation about the container axis may be rotation of the container through 90 degrees or rotation through an angle of smaller than or larger than 90 degrees. When the container is in the filling position, the orifice may point vertically or obliquely upward. When the container is in the transfer position, the orifice may point vertically or obliquely to the side.

According to the solution, the articles are introduced from above through the orifice into the container which is in the filling position. This refinement requires less work than if the container had to be tilted for filling purposes. It is possible, but not necessary, to use a handling robot or a handling appliance for loading the container. It is possible that a plant causes the articles to slide automatically into the container. Gravity and therefore the weight of the articles accelerate and facilitate the introduction of the articles through the upwardly pointing orifice.

According to the solution, the articles are extracted from the container, which is in the transfer position, as a result of lateral movement. This lateral movement reduces the risk that articles are damaged or lost during unloading. Furthermore, the invention reduces the risk that the order of the articles of the stack in the container is changed. It is often desirable that the order be maintained during transport, this being made possible by the invention. The lateral movement requires less mechanical work than if the container had to be placed on its head for unloading purposes or the articles had to be extracted from the container upwardly.

The step of rotating the container, together with the articles, about the container longitudinal axis requires less mechanical force, this effect occurring particularly because only a little lifting work has to be performed since the articles are to be lifted only by a small amount, if at all.

In one refinement, the container is brought at least once into a transport position in which the pivotable parallel wall is closed. In another refinement, the container is transported at least once in the filling position to the destination. The container therefore remains in the filling position while it is being transported to the destination. This refinement avoids the need for the step of having to tilt the filled container or pivot it otherwise, before the container is transported. At the destination, the container is brought into the transfer position, the container being rotated about the currently horizontal container axis. This rotation requires little mechanical effort and little force.

Preferably, the pivotable parallel wall closes the orifice. It thereby becomes possible to provide a large orifice through which articles can be introduced quickly and can be extracted from the container again.

In one refinement, the method for the sorting of stackable articles is used. One sorting feature is stipulated. In order to sort the stackable articles, two sorting runs are carried out. In a first sorting run, the articles are distributed according to the stipulated sorting feature to the sorting end points of the sorting plant. For this purpose, preferably, a first sorting plan is used which assigns in each case a sorting end point to each possible value of the sorting feature. In the second sorting run, too, the sorting plant distributes the stackable articles to the sorting end points according to the stipulated sorting feature. In the second sorting run, preferably, a second sorting plan is used which assigns in each case a sorting end point to each possible value of the sorting feature.

After the first sorting run, in each case a transport operation is carried out for each sorting end point of the sorting plant. In this transport operation, all the stackable articles which the sorting plant has fed out to the sorting end point in the first sorting run are transported to the supply device of the sorting plant. This transport to the supply device makes it possible that the articles from the sorting end point run through the sorting plant anew in the second sorting run. This transport operation contains the steps of the method according to the solution. In this transport operation, a container according to the solution is used.

Other features which are considered as characteristic for the invention are set forth in the appended claims.

Although the invention is illustrated and described herein as embodied in a method and an apparatus for the transporting and sorting of articles by use of a container, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a container with a vertical longitudinal axis;

FIG. 2 is an illustration of a sorting plant with a plurality of containers according to the solution;

FIG. 3 is a side view of the container of FIG. 1 in the filling position, the longitudinal axis lying in the drawing plane;

FIG. 4 is a further side view of the container of FIG. 3, the longitudinal axis standing vertically on the drawing plane;

FIG. 5 is a side view of the container of FIG. 1 in the transfer position, the longitudinal axis lying in the drawing plane; and

FIG. 6 is a further side view of the container of FIG. 5, the longitudinal axis standing vertically on the drawing plane.

### DETAILED DESCRIPTION OF THE INVENTION

In the exemplary embodiment, a container according to the solution is used in order to transport and temporarily store flat mail consignments (large letters, standard letters, catalogues, periodicals, etc.).

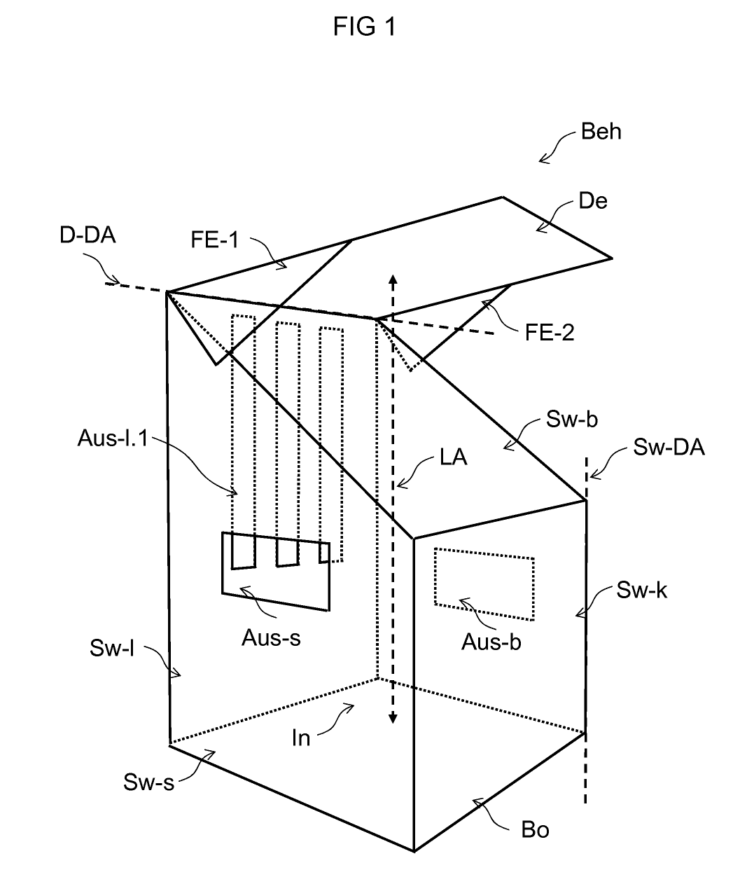

Referring now to the figures of the drawing in detail and first, particularly, to FIG. 1 thereof, there is shown a container Beh according to the solution, which stands on its bottom, so that its longitudinal axis LA stands vertically.

The container Beh possesses six delimiting walls which delimit an inner space In. The container Beh has a longitudinal extent in the direction of a longitudinal axis LA. If the container Beh is oriented such that the longitudinal axis LA runs vertically, the container Beh stands on-edge on a wall Bo which is designated below as the “bottom”. The bottom Bo is rectangular or trapezoidal. The longitudinal axis LA is not necessarily the longest axis of the container Beh.

Four vertically standing side walls delimit the inner space In laterally. In the exemplary embodiment, two side walls Sw-l, Sw-k have the form of rectangles, to be precise the form of a smaller rectangle and the form of a larger rectangle. The rectangular side wall Sw-l in the form of a larger rectangle is designated as the “longest side wall”, and the opposite rectangular side wall Sw-k as the “shortest side wall”. The other two side walls Sw-b, Sw-s have identical dimensions, in each case four corners and the form of a rectangle out of which a right-angled triangle has been cut out. These two side walls are designated as “sloped side walls” Sw-b, Sw-s.

The longitudinal axis LA functions as the container axis within the meaning of the claims. The bottom Bo functions as a perpendicular wall since the bottom Bo stands perpendicularly on the longitudinal axis LA. The four side walls Sw-l, Sw-k, Sw-b, Sw-s function as the four parallel walls, since the longitudinal axis LA runs parallel to each of these four side walls Sw-l, Sw-k, Sw-b, Sw-s.

Preferably, the four side walls Sw-l, Sw-k, Sw-b, Sw-s do not butt one on the other in each case at right angles. Instead, the bottom Bo has a trapezoidal configuration. That edge of the bottom Bo in which the longest side wall Sw-l is contiguous to the bottom Bo is shorter than the opposite edge. If the container Beh is positioned such that the longest side wall Sw-l points downward and the shortest side wall Sw-k points upward and the longitudinal axis runs horizontally, the container Beh widens upward, that is to say tapers downward. This configuration makes it possible to stack a plurality of containers according to the solution with completely open shortest side walls Sw-k one in the other and one above the other, thus saving space.

That wall of the container Beh which is at the top when the container stands with the vertical longitudinal axis LA on its bottom Bo is designated as the “lid” De. The lid De is connected movably to one side wall, preferably to that longest side wall Sw-l which has the form of the larger rectangle. The lid De can be swung open and shut by rotation or by other pivoting. In the folded-shut state, the lid De lies on the two sloped side walls Sw-b, Sw-s and the shortest side wall Sw-k. The lid axis of rotation D-DA about which the lid De is mounted rotatably forms at the same time the upper terminating edge of the longest side wall Sw-l.

It is also possible that the lid De is somewhat smaller than the rectangular orifice which is delimited by the upper edges of the four side walls Sw-l, Sw-k, Sw-b, Sw-s. The closed lid De almost fills this orifice and is preferably flush with the four upper edges. At least one fastening element of the lid holds the lid De in this position. The at least one fastening element engages into a matching reception element of a side wall. When the lid De is being closed, the fastening element latches into the reception element. Preferably, the lid De has a grip so that it can be opened and closed more easily.

In the exemplary embodiment, the shortest side wall Sw-k is likewise mounted rotatably, specifically about a side wall axis of rotation S-DA. The shortest side wall Sw-k is connected rotatably to the one sloped side wall Sw-b and is not connected to the bottom Bo, not to the lid De and not to the other sloped side wall Sw-s. This sloped side wall to which the shortest side wall Sw-k is fastened rotatably is designated below as the “fastening sloped side wall” Sw-b. The other sloped side wall is designated as the “supporting sloped side wall” Sw-s.

It is also possible that the shortest side wall can be displaced or otherwise pivoted in relation to the fastening sloped side wall Sw-b.

Preferably, the shortest side wall Sw-k can be rotated through 270° about the side wall axis of rotation. In the closed position, the shortest side wall Sw-k lies with its free end against the supporting sloped side wall Sw-b against or on the latter. In the completely open position, the shortest side wall Sw-k bears over a large area against the fastening sloped side wall, that is to say against the side wall Sw-b to which the shortest side wall is connected rotatably.

Instead of the shortest side wall Sw-k being pivotable as a whole with the fastening sloped side wall Sw-b, the shortest side wall Sw-k can also have a doorframe. The doorframe is connected fixedly to the bottom Bo and the two sloped side walls Sw-b, Sw-s. A door is introduced into the doorframe and is mounted rotatably about the side wall axis of rotation S-DA. The longest side wall Sw-l is connected fixedly to the bottom Bo and to the two sloped side walls Sw-b, Sw-s. The bottom Bo is connected fixedly to the two sloped side walls Sw-b, Sw-s.

In the exemplary embodiment, clearances, which are explained further below, are introduced into the two sloped side walls Sw-b, Sw-s and into the longest side wall Sw-l.

In FIG. 1 can be seen a clearance Aus-b in the fastening sloped side wall Sw-b, a clearance Aus-s in the supporting sloped side wall Sw-b and three clearances Aus-1.1, Aus-1.2 and Aus-1.3 in the longest side wall Sw-l.

Preferably, two sheet-like guide elements FE-1, FE-2 are arranged at the margin of the lid De. If the lid De is closed, these sheet-like guide element FE-1, FE-2 bear against the two sloped side walls, specifically, preferably, on the outside. The guide elements FE-1, FE-2 are therefore located outside the container inner space.

Preferably, the container Beh has a locking device. By virtue of this locking device, the open lid De can be locked in at least one specific position. FIG. 1 shows the locked lid De.

It is also possible that the locking device does not operate discretely, but continuously, that is to say can lock the lid De in any position between complete closing and complete opening. The lid De can be moved only counter to certain mechanical resistance. If the lid De can be locked continuously or in a plurality of discrete positions, it is possible to reach into the container, but the lid De protects the articles in the container Beh, for example from rain or splashes of water.

In one refinement, all six walls or at least the four side walls are manufactured from a transparent material, for example from scratchproof plastic. It can therefore be seen from outside what is located inside the container.

In another refinement, all the walls are manufactured from opaque material, for example from hard plastic.

Preferably, the walls and also the clearances possess rounded corners.

Preferably, at least one fastening element, for example a snap fastening (“clip”), as on a briefcase, is fastened to the free end of the shortest, rotatably mounted side wall Sw-k. The fastening element latches into at least one matching reception element of the supporting sloped side wall Sw-s. These elements prevent the shortest side wall Sw-k from opening by itself, for example during transport. However, the elements are configured such that a worker or handling robot can open the side wall Sw-k.

Preferably, the fastening sloped side wall Sw-b also possesses reception elements. These reception elements are located near the edge between the fastening sloped side wall Sw-b and the longest side wall Sw-l. If the shortest side wall Sw-k is completely open, the fastening elements of the free end of the shortest side wall Sw-k latch into these reception elements. This prevents the situation where the completely open shortest side wall Sw-k may rotate by itself and, for example, injure a person's hand.

Preferably, clearances Aus-b, Aus-s are introduced into the two sloped side walls Sw-b, Sw-s. Or grips are attached to both side walls. With the aid of these clearances Aus-b, Aus-s or grips, a worker or handling robot can transport the container, specifically, preferably such that the longitudinal axis LA stands vertically during transport.

In the exemplary embodiment, a multiplicity of containers according to the solution are used for transporting mail consignments to a sorting plant and conveying them within this sorting plant.

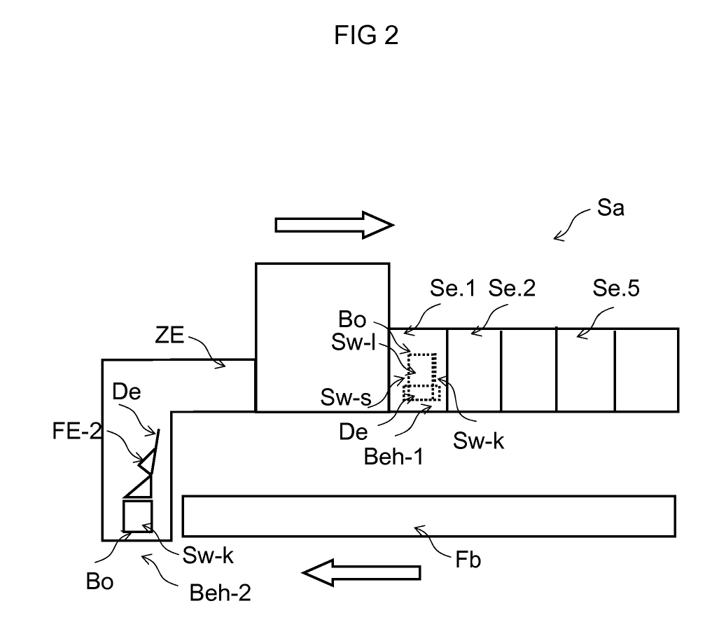

FIG. 2 shows a sorting plant which sorts mail consignments with the aid of a plurality of containers according to the solution. Two containers Beh-1, Beh-2 according to the solution can be seen.

The sorting plant Sa sorts the mail consignments according to a stipulated delivery round sequence (“delivery sequence”) under stipulated destinations (“delivery points”), for example under delivery addresses. After sorting by delivery round sequence, the mail consignments are sorted according to this delivery round sequence. The letter delivery workers can distribute these mail consignments, without having to sort them once again.

The sorting plant Sa has a multiplicity of sorting end points Se.1, Se.2, etc. Each sorting end point Se.1, Se.2, etc. is configured such that mail consignments can be introduced at this sorting end point into a container according to the solution. However, because there are markedly more possible destinations for mail consignments in the delivery round sequence than sorting end points, the mail consignments run through the sorting plant in at least two sorting runs (“n-pass sequencing”).

The mail consignments are collected from letterboxes, mailbox installations and/or pick-up points and transported to a pretreatment device. Mail consignments and other articles which are not machine-capable are sorted out there.

The remaining, that is to say machine-capable mail consignments are introduced into containers according to the solution prior to the first sorting run and are transported in these containers to the sorting plant Sa. The sorting plant possesses a supply device ZE (“feeder”) with a separator (“singulator”). The mail consignments are extracted from the containers and brought, in each case as at least one stack per container, onto the supply device ZE. The supply device ZE transports the mail consignments to the separator.

The separator is configured for separating a stack of upright mail consignments. The separator separates the mail consignments such that a stream of upright mail consignments spaced apart from one another leaves the separator.

In the first sorting run, the sorting plant Sa reads the respective destination on the mail consignment, stores an identification of this destination and feeds out the mail consignments to a sorting end point Se.1, Se.2, etc. To which sorting end point the sorting plant feeds out the mail consignment depends on the destination read in each case and on a stipulated sorting plan which the sorting plant evaluates automatically.

The mail consignments are transported from the respective sorting end point Se.1, Se.2, etc. back to the supply device ZE in the containers Beh-1, Beh-2 according to the solution. In this case, the containers stand on a conveying device Fb of the sorting plant Sa, for example on a system of horizontal endless conveyor belts.

A soon as a container reaches the supply device ZE, the mail consignments are extracted from the container and brought again in the form of at least one stack onto the supply device ZE. The supply device ZE transport the stack anew to the separator, and the separator separates the mail consignments.

In the second sorting run, the mail consignments run anew through the sorting plant Sa. The sorting plant Sa determines for each mail consignment the destination stored in each case. The sorting plant allocates anew the mail consignments to the sorting end points Se.1, Se.2, etc. and, for this purpose, uses the stored and determined destinations. After the last sorting run, the mail consignments are distributed to the sorting end points Se.1, Se.2, etc. according to the stipulated delivery round sequence and the stipulated sorting plan and are also sorted, within a sorting end point, according to the delivery round sequence.

The mail consignments are therefore introduced preferably three times into containers according to the solution during two sorting runs, to be precise,

for the first time, prior to the first sorting run, in order to be transported in these containers to the pretreatment device and from this device for the first time to the sorting plant,

for the second time, after the first sorting run and prior to the second sorting run, in order to transport the mail consignments from the sorting end points Se.1, Se.2, etc. back to the supply device ZE, and,

for the third time, in order to transport the sorted mail consignments away from the sorting end points Se.1, Se.2, etc.

It is also possible to use the containers according to the solution solely within the sorting plant Sa, to be precise, after one sorting run, to transport mail consignments from a sorting end point Se.1, Se.2, etc. back to the supply device ZE, so that the mail consignments run anew through the sorting plant in a subsequent sorting run. The containers according to the solution therefore remain in the sorting plant Sa in this refinement. In order to transport the mail consignments to the sorting plant Sa and in order to transport them away from the sorting end points Se.1, Se.2, etc., other containers are used in this refinement.

After a sorting run, in each case a stack of mail consignments is brought from the sorting end point Se.1, Se.2, etc. to the supply device ZE. The order of the mail consignments in the stack in this case is maintained, that is to say is not changed. This is often desirable in order to avoid errors during sorting.

In order to fill a container according to the solution with mail consignments, the container is brought into a filling position. The container is in the filling position both when the mail consignments are to be introduced into the container prior to the first sorting run and when the sorting plant Sa fills the container in a sorting end point Se.1, Se.2, etc. after a sorting run.

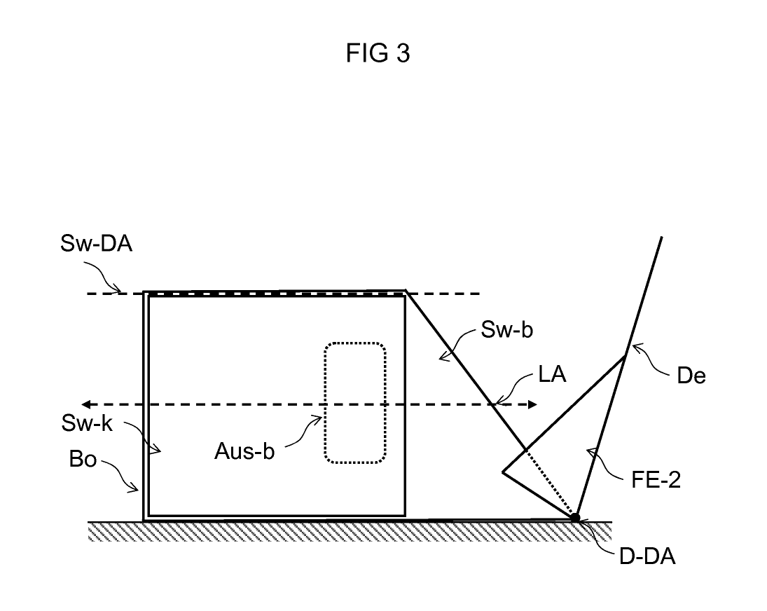

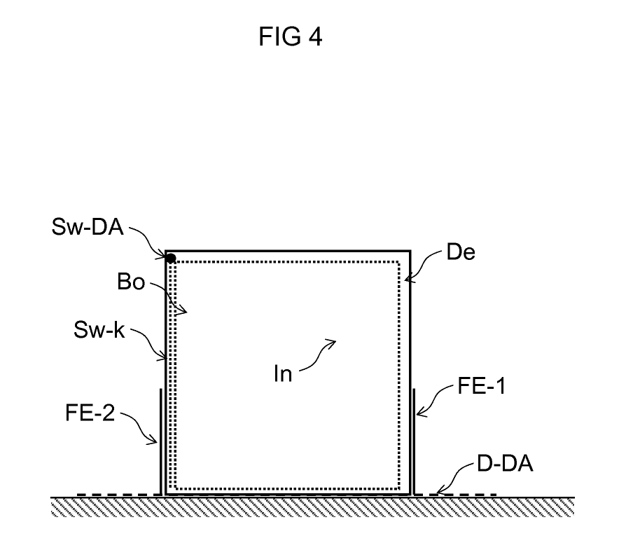

FIG. 3 shows a side view of the container in the filling position, the longitudinal axis lying in the drawing plane. FIG. 4 shows the container from FIG. 3 in another side view, the longitudinal axis standing vertically on the drawing plane. FIG. 2 shows a container Beh-1 according to the solution in a filling position under the sorting end point Se.1.

In this filling position, the longest side wall Sw-l points downward and the shortest side wall Sw-k upward. The bottom Bo stands vertically. The longitudinal axis LA of the container runs horizontally. The longest side wall Sw-l with the lid axis of rotation D-DA, about which the lid De is mounted rotatably, lies on a bearing surface. The rotatably mounted shortest side wall Sw-k is rotated such that an upwardly pointing orifice is obtained in the container. If the shortest side wall Sw-k previously rested on both sloped side walls Sw-b, Sw-s, the shortest side wall Sw-k is rotated about the side wall axis of rotation Sw-DA. Preferably, the shortest side wall Sw-k is also connected at its free end to the fastening sloped side wall Sw-b, so that the two side walls Sw-k, Sw-b run parallel to one another. Preferably, the lid De is closed when the container is in the filling position, so that no mail consignment can fall out of the container.

As already stated, in one refinement, a container according to the solution is used for bringing mail consignments to the supply device ZE of the sorting plant prior to the first sorting run. In this application, the supply device ZE functions as a destination.

In order to bring the mail consignment to the sorting plant prior to the first sorting run, in each case a plurality of mail consignments are introduced into a container according to the solution and are stacked there. As soon as a container according to the solution is filled, the full container is brought out of the filling position into a transport position. In order to bring the container into the transport position, the lid De and the shortest side wall Sw-k are closed. The lid De is rotated, for this purpose, about the lid axis of rotation D-DA, and the shortest side wall Sw-k about the side wall axis of rotation Sw-DA. The fastening elements latch into the matching reception elements.

It is possible to rotate the container through 90° such that the longitudinal axis LA stands vertically and the bottom points downward. It is also possible to leave the container, for transportation, in a position in which the longitudinal axis LA runs horizontally.

As already stated, the supply device ZE contains a separator (“singulator”). The separator is configured for separating a stack of upright mail consignments. The mail consignments to be separated must previously be aligned along two edges. The separator separates the mail consignments such that a stream of upright mail consignments spaced apart from one another leaves the separator.

Moreover, the supply device ZE possesses an alignment device which precedes the separator. In one refinement, the mail consignments are as far as possible aligned as early as in the container and, already partially aligned, reach the following alignment device.

Preferably, for this purpose, the container is brought successively into two alignment positions. In both alignment positions, the lid De and the shortest side wall Sw-k are closed. In one alignment position, the one sloped side wall points downward and the other sloped side wall upward. The longitudinal axis LA runs horizontally. Gravity aligns the mail consignments standing upright in the container, such that the mail consignments are aligned along the edges with which the mail consignments stand on the lower sloped side wall.

The container is then brought, with the lid De closed and with the shortest side wall Sw-k closed, into the other alignment position. In this other alignment position, the bottom Bo is below, and the longitudinal axis La stands vertically. Furthermore, the mail consignments stand upright in the container. Gravity then aligns the mail consignments on the bottom Bo. The mail consignments are thereafter aligned along two edges.

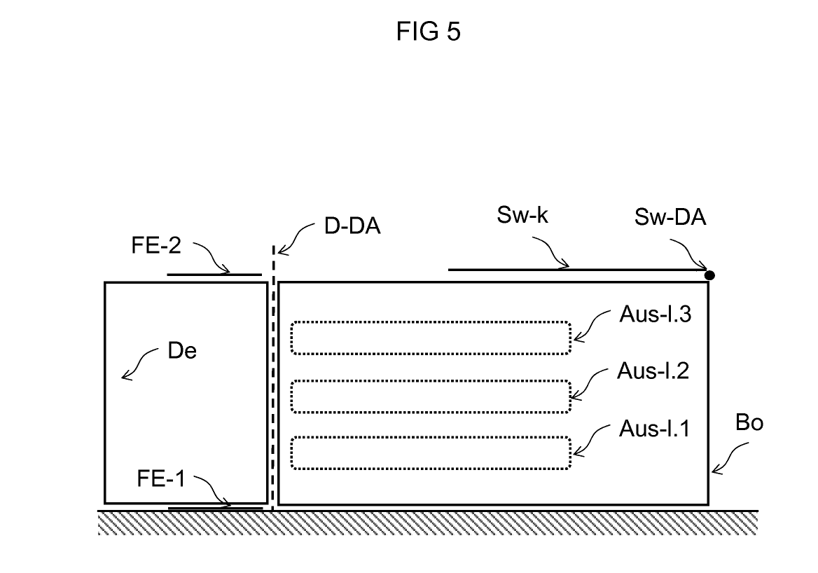

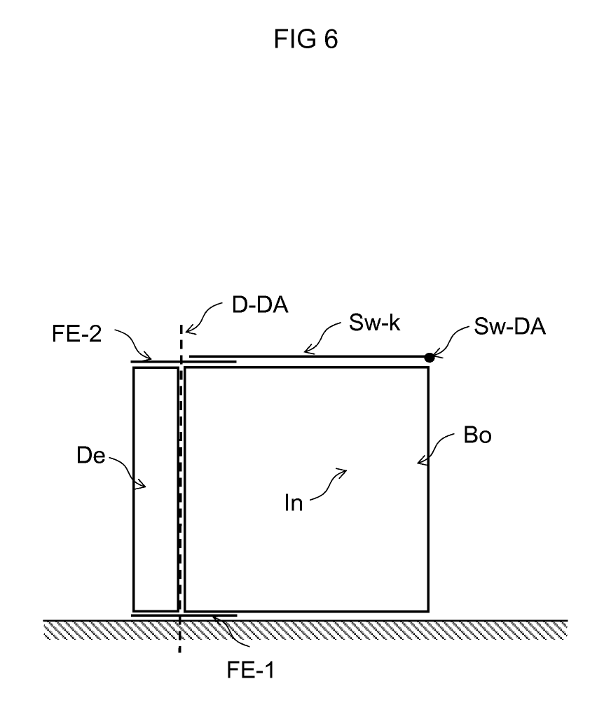

The container is then brought into a transfer position. FIG. 5 shows the container Beh-1 according to the solution in the transfer position on the supply device ZE. FIG. 6 shows the container from FIG. 5 in another side view, the longitudinal axis standing vertically on the drawing plane. FIG. 2 shows a container Beh-2 according to the solution on the supply device ZE.

A container according to the solution is brought into the transfer position whenever the mail consignments are to be transferred out of the container onto the supply device ZE, in order thereafter to run through the sorting plant in a sorting run. In this transfer position, the longitudinal axis LA of the container runs horizontally. The fastening sloped side wall Sw-b points upward and the supporting sloped side wall Sw-b downward. The container therefore rests on the supporting sloped side wall Sw-s.

The shortest side wall Sw-k and the lid De are opened. Preferably, the shortest side wall Sw-k is as far as possible rotated about the side wall axis of rotation S-DA and thereby opened completely, so that the shortest side wall Sw-k lies on the fastening sloped, then upper side wall Sw-b. The lid De is opened at least to an extent such that the lid De and the longest side wall Sw-l form one plane, preferably is opened even further. The mail consignments stand upright on the supporting sloped, then lower side wall Sw-s.

Since the shortest side wall Sw-k is opened completely, the upright mail consignments may fall over and fall out of the container. This is undesirable. A holding element therefore presses laterally against the stack of mail consignments and presses the stack against the longest side wall Sw-l. Since the shortest side wall Sw-k is completely open, the holding element can engage into the inner space of the container through the orifice thereby occurring. The holding element possesses a supporting face and, for example, has the form of a punch or mushroom with a horizontal stem.

Preferably, clearances Aus-1.1, Aus-1.2, Aus-1.3 in the form of slots, which run parallel to the longitudinal axis, are introduced into the longest side wall Sw-l. Owing to these slots, a further holding element can engage into the inner space of the container. This further holding element has, for example, a fork-shaped element, each prong of this fork fitting in each case through a slot. Slots and prongs are configured correspondingly. It thereby becomes possible that the holding element and the further holding element clamp the stack of upright mail consignments between them and displace them out of the container as a result of synchronized movement of the two holding elements.

It is also possible that the two holding elements grasp the stack, and the container is drawn off. In both instances, relative movement between the held stack and the container is executed.

In one refinement, the further fork-shaped holding element engages from outside through the longest side wall Sw-l into the inner space of the container. In another refinement, the fork-shaped further holding element is led into the container inner space through the orifice which has occurred as a result of the opening of the lid De.

The stack of mail consignments is pressed away from the longest side wall Sw-l as a result of this movement.

Preferably, the container remains in the filling position while the conveyor belt transports the full container back to the supply device. This avoids the need for the step of moving the container manually into another position for transport back to the supply device. Instead, filling and return transport can be carried out completely automatically.

During transport back to the supply device ZE, the shortest side wall Sw-k remains open. It is connected releasably to the fastening sloped side wall Sw-b or locked in a specific position by the fastening and reception elements. The lid De, too, is fastened or locked. The lid De remains in the position in which it was while the container was being filled. This prevents the situation where the lid De or the shortest side wall Sw-k moves in relation to the container during transport, which could damage the sorting plant or the lid De or the side wall Sw-k.

The container is transported in the filling position, together with the mail consignments, back to the supply device ZE. As soon as the full container has reached the supply device ZE, a holding element engages, as described above, into the interior of the container through that orifice which has occurred as a result of the opening of the shortest side wall Sw-k. Since this orifice points upward, the holding element engages into the container from above.

The full container is subsequently brought into the transfer position. For this purpose, the container is rotated about its longitudinal axis LA. After rotation, the container lies on the supporting sloped side wall Sw-s. The shortest side wall Sw-k remains open. Only after rotation is the lid De opened so that a further holding element can engage into the inner space of the container through the orifice which occurs as a result of the opening of the lid De.

Preferably, the stack of mail consignments in the container is pressed against the longest side wall Sw-l by the above-described holding element during rotation. The holding element engages through that orifice which has occurred as a result of the opening of the shortest side wall Sw-k. For example, the holding element holds the stack while the full container is being rotated.

The stack of mail consignments is brought onto the supply device ZE, specifically, preferably, with the aid of the holding device. The stack is transported to the separator. The separator separates the stack. The mail consignments run through the sorting plant Sa in the second sorting run. The sorting plant distributes the mail consignments to the sorting end points Se.1, Se.2, etc.

The mail consignments are subsequently introduced into containers again, as described above. Preferably, after the second sorting run, the containers are also introduced into the containers according to the solution which are in the filling position.

After the last sorting run, too, in one refinement, the mail consignments are introduced into containers according to the solution. In this refinement, these containers are transported to the letter delivery workers. During transport, each container is in a transport position.

A delivery worker picks up a full container and transports the container along a delivery route. This delivery route is part of the overall delivery round sequence. In this case, the delivery worker with the container reaches the destinations of his delivery route in succession. The delivery worker distributes the mail consignments correctly to the destinations. In the exemplary embodiment, the mail consignments are already sorted according to the delivery round sequence. The delivery worker therefore needs only in each case to extract the foremost mail consignment or the front mail consignments out of the container in which the mail consignments stand upright. It is also possible, however, that the delivery worker extracts a mail consignment from inside the stack in the container.

In order to make it easier to extract mail consignments, the container is brought into an extraction position.

It is sometimes desirable to inspect the mail consignments in the container manually and to extract individual mail consignments from the container, for example damaged mail consignments. Or else a plurality of mail consignments which are caught together are to be parted from one another manually. For these purposes, too, the container is brought into an extraction position.

In this extraction position, the longitudinal axis runs vertically or obliquely. The container stands on the bottom Bo. The mail consignments stand upright on the bottom Bo. The container is oriented such that the shortest, then vertical side wall Sw-k points toward a worker or a handling robot. By a slight oblique setting of the longitudinal axis LA, an especially ergonomic position of the container can be achieved. The oblique setting is achieved in that the container is placed onto an oblique base. The lid De is opened, and the shortest side wall Sw-k remains closed. Preferably, the lid De is locked by the locking device. A worker can then reach the mail consignments inside the container.

By virtue of the refinement with side walls of different length, it becomes easier for a worker, delivery worker or handling robot to have access to specific mail consignments. Access will be markedly more difficult if the container were in the form of a parallelepiped.

1. A method for transporting a plurality of stackable articles using at least one container containing an inner space extending along a container axis, a bottom wall, and a plurality of parallel walls, the bottom wall and the parallel walls delimiting the inner space, the bottom wall standing perpendicular to the container axis, each of the parallel walls being disposed parallel to the container axis, and one of the parallel walls being a pivotably fastened parallel wall connected pivotably to another one of the parallel walls, which comprises the steps of:
bringing the container into a filling position in which the container stands on one of the parallel walls, so that the container axis runs horizontally, and the pivotably fastened parallel wall points upward and is opened so that an upwardly pointing orifice occurs;
introducing the stackable articles into the inner space of the container from above through the upwardly pointing orifice, so that the stackable articles, after being introduced, form a stack located in the container;
transporting the container, together with the articles, to a destination;
bringing the container into a transfer position by rotating the container, together with the articles in the container, about the container axis, in the transfer position the container stands on one of the parallel walls, so that the container axis runs horizontally, and the pivotably fastened parallel wall points to one side, so that a side orifice pointing to the one side occurs; and
extracting the stack with the articles from the inner space of the container through the side orifice pointing to the one side.

2. The method according to claim 1, which further comprises holding the stack, during extraction from the container located in the transfer position, and being moved by means of a holding device, an element of the holding device engaging through the side orifice pointing to the side.

3. The method according to claim 2, wherein the stack leans against one of the parallel walls after the container has been brought into the transfer position, and a further element of the holding device engages through at least one clearance in the one parallel wall.

4. The method according to claim 1, which further comprises:
allocating the stackable articles to a plurality of intermediate stores;
bringing the intermediate stores successively into a transfer position with respect to the container; and
opening an orifice in the intermediate store when the intermediate store is located in the transfer position, so that the stackable articles slide out of the intermediate store into the container.

5. The method according to claim 1, which further comprises:
bringing the container filled with the stackable articles at least once into a position in which the container axis runs vertically or points obliquely upward and the stackable articles stand on the bottom wall then pointing downward; and
pivoting the pivotably fastened parallel wall such that its free end bears against a further one of the parallel walls of the container, and a temporary connection is made between the pivotably fastened parallel wall and the further parallel wall.

6. The method according to claim 5, which further comprises extracting at least one article at least once out of the container, the container axis of which runs vertically or runs obliquely upward, as a result of a movement parallel to the container axis.

7. The method according to claim 1, which further comprises
keeping the container in the filling position while it is being transported to the destination; and
during the step of bringing the container into the transfer position at the destination, carrying out the step of rotating the container about its container axis.

8. The method according to claim 7, wherein a holding element presses the stack in the container against one of the parallel walls while the container is being rotated about the container axis.

9. A method for sorting stackable articles via a sorting plant having a supply device and a plurality of sorting end points, the method comprises the steps of:
in a first sorting run, distributing, via the sorting plant, the articles to the sorting end points according to a stipulated sorting feature;
for each sorting end point the articles sorted into the sorting end point are transported to the supply device by means of the following steps:
providing at least one container containing an inner space extending along a container axis, a bottom wall, and a plurality of parallel walls, the bottom wall and the parallel walls delimiting the inner space, the bottom wall standing perpendicular to the container axis, each of the parallel walls being disposed parallel to the container axis, and one of the parallel walls being a pivotably fastened parallel wall is connected pivotably to another one of the parallel walls;
bringing the container into a filling position in which the container stands on one of the parallel walls, so that the container axis runs horizontally, and the pivotably fastened parallel wall points upward and is opened so that an upwardly pointing orifice occurs;
introducing the stackable articles into the inner space of the container from above through the upwardly pointing orifice, so that the stackable articles, after being introduced, form a stack located in the container;
transporting the container, together with the articles, to a destination;
bringing the container at the destination into a transfer position by rotating the container, together with the articles in the container, about the container axis, in the transfer position the container stands on one of the parallel walls, so that the container axis runs horizontally, and the pivotably fastened parallel wall points to one side, so that a side orifice pointing to the one side occurs; and
extracting the stack with the stackable articles from the inner space of the container through the side orifice pointing to the one side; and
in a second sorting run, distributing, via the sorting plant, the stackable articles to the sorting end points according to the sorting feature.

10. A configuration for sorting stackable articles, the configuration comprising:
at least one container;
a sorting plant having a supply device and a plurality of sorting end points, each of said sorting end points having in each case a bearing surface in each case for said at least one container, said supply device having a further bearing surface for said at least one container;
said at least one container containing an inner space extending along a container axis, a bottom wall, and a plurality of parallel walls, said bottom wall and said plurality of parallel walls delimiting said inner space, said bottom wall standing perpendicular to said container axis, each of said parallel walls disposed parallel to said container axis, and one of said parallel walls being a pivotably fastened parallel wall connected pivotably to another one of said parallel walls;
said sorting plant configured such that said container can be brought into a filling position onto said bearing surface of said sorting end point;
said container disposed in the filling position standing on one of said parallel walls, so that the container axis runs horizontally, said pivotably fastened parallel wall pointing upward and being opened, so that an orifice pointing upward occurs;
said sorting plant configured for causing the articles sorted into said sorting end point to slide into said inner space of said container from above through said orifice;
said sorting plant being configured, furthermore, for causing said container to be brought into a transfer position on said bearing surface of said supply device;
said container disposed in the transfer position standing on one of said parallel walls, so that said container axis runs horizontally; and
said pivotably fastened parallel wall pointing to one side, so that a side orifice pointing to said one side occurs, through which the stack of articles can be extracted from said inner space of said container.
